(19) United States
(12) Patent Application Publication
(10) Pub. No.: US 2011/0161298 A1
(43) Pub. Date: Jun. 30, 2011

(54) SYSTEM AND METHOD FOR OPPORTUNISTIC RE-IMAGING USING CANNIBALISTIC STORAGE TECHNIQUES ON SPARSE STORAGE DEVICES

(76) Inventors: Steven L. Grobman, El Dorado Hills, CA (US); Robert W. Strong, Folsom, CA (US)

(21) Appl. No.: 12/649,273

(22) Filed: Dec. 29, 2009

(51) Int. Cl. G06F 12/16; G06F 17/30

(52) U.S. Cl. 707/649; 707/E17.005

(57) ABSTRACT

In some embodiments, the invention involves a system and method for instant re-imaging of a computing device using a sparse storage partition of dynamically variable size to hold re-imaging data. An embodiment uses a solid state storage device to hold the binary image, or re-imaging personality. An embodiment uses copy on write methodology to maintain the re-imaging personality. An embodiment allows the primary, or active, personality to cannibalize storage used for a re-imaging personality when additional storage is required. The state of a computing device may be switched to allow or prohibit re-imaging, or to prohibit cannibalization of storage. Other embodiments are described and claimed.

### FIELD OF THE INVENTION

An embodiment of the present invention relates generally to re-imaging of computer systems and, more specifically, to using cannibalistic storage techniques on sparse storage devices, typically solid state storage, to quickly re-image a computing platform to a known environment or state.

### BACKGROUND INFORMATION

When users have problems with their computers, the first step to resolving the problem is often to call an information technology (IT) expert. Often the troubleshooting takes place during a teleconference and/or via remote access because the user is not co-located with IT personnel. If the IT expert cannot solve the problem within a certain amount of time, often the next step is to rebuild the computer's operating system environment to a known good state. This rebuilding may also be known as re-imaging of the computer, or replacing the binary image of the operating system, patches, service packs, security software, anti-virus and core applications or line of business applications. If the IT expert is not co-located the user may be forced to attempt his/her own rebuild, or send the computer to another site for repair. This can be a time consuming and manual process, often leaving the user without use of the computer for hours or days. In some cases, this can also result in a loss of data.

Various mechanisms exist for re-imaging a computing device. One method is to enable an enterprise IT (information technology) organization to instantly re-image a PC from an image stored in a secondary location on the computing device instead of manually loading an image onto the PC. This is highly beneficial to both IT and the user from the standpoint that minimal time is required to convert the re-image personality to the drive's primary personality. The capability is especially beneficial in mobile environments where loading a new image over the network is impractical or highly time consuming. The general concept of re-imaging is known in the art; however existing methods may require the secondary device to be of the same size as the image being replaced. In some cases, the replacement image may be compressed, but a recovery partition typically will require dedicated storage on the device which will require a dedicated partition that is large enough to store a compressed image for recovery. This recovery mechanism typically results in loss of data as the image stored on a secondary location restores the computer to its factory default state.

In some existing systems the storage device may be partitioned into user space and re-image space. The re-image space stores a known good image that may be copied with relative ease back to the user space. However, the re-image may take up a significant amount of space that is permanently partitioned and unavailable to the user. Thus, the advertised size of the storage is not the size available to the user, as a good portion of it must permanently hold the re-image.

### BRIEF DESCRIPTION OF THE DRAWINGS

The features and advantages of the present invention will become apparent from the following detailed description of the present invention in which:

FIG. 1 is a block diagram illustrating the logical views of physical storage, according to an embodiment of the invention;

FIG. 2 is a block diagram illustrating the use of copy on write (COW) methodology to maintain a re-imaging personality, according to an embodiment of the invention;

FIG. 3 is a state diagram illustrating general state transitions of the device, according to an embodiment of the invention;

FIG. 4 is a block diagram illustrating how the data from both personalities is stored in physical storage, according to an embodiment of the invention; and

FIGS. 5 and 6 are block diagrams illustrating both exemplary server and client platforms which may be utilized in implementation of various embodiments of the invention and configured to allow out-of-band communication to control the re-imaging.

### DETAILED DESCRIPTION

Embodiments of the invention utilize an “Instant” re-image use model allowing a secondary sparse partition to be stored on a solid state storage device (SSD). It should be noted that while the term “partition” is used herein for simplicity, the secondary partition is really just a logical portion of physical storage that may be stored non-contiguously and may dynamically change in size. This secondary sparse partition may have the same logical size as the primary SSD storage space, but because it is sparse, the physical storage will be only a small percentage of the logical space. The use model for this secondary sparse personality is to enable an enterprise IT organization to instantly re-image a PC instead of manually loading an image onto the PC. It should be noted that the term personality is used herein to indicate that a device can appear to be different storage mediums based on the device state. This implies that the data on the device will look different depending on state elements associated with the device. A typical use of personality is to have a device boot a minimal environment that can interact with the user in order to obtain cryptographic credentials and “unlock” this primary personality of the device. The use of personalities for the usage models is used in a similar matter in the following description.

Embodiments improve the solution space for re-imaging by allowing all of the available capacity of the storage device to be available to the user if they require it, however the user may utilize the re-image feature under certain circumstances, for instance, when the primary view of the drive has not encroached or cannibalized physical space that is being used for the re-image partition. In an alternate embodiment, the re-image requirements may be pre-allocated and the primary view of the drive decreased by the physical needs of the re-image image (even though the logical size of the re-image drive matches the main active personality). Further, the sparse personality is dynamic in the way it utilizes physical storage so there is no risk of selecting a permanent partition size which is outgrown by the image as time goes on.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

In an embodiment, multiple “logical to physical” (L2P) translation tables are generated. One of these tables is the “Active” implementation, or personality, and is accessed for all standard SSD input/output (I/O) operations. The second L2P table may be used to manage the re-image partition. This secondary L2P table is manipulated either with custom read, write and trim commands, or through initial population via a “snapshot” command that duplicates the contents of the primary L2P table. By implementing commands that can modify the re-image image, IT may make updates, etc. For example, it should be possible to mount the “hidden” image and make changes, sometimes known as “patches,” or even re-image the hidden image. It should be noted, that other forms of snapshot beyond duplication may be supported. L2P tables may point to the same physical storage, initially, with optimization for read or write (also known as, look to alternate table on read or write based on an optimization vector). However, for purposes of illustration, embodiments are described assuming that physical storage is only referenced by one L2P table.

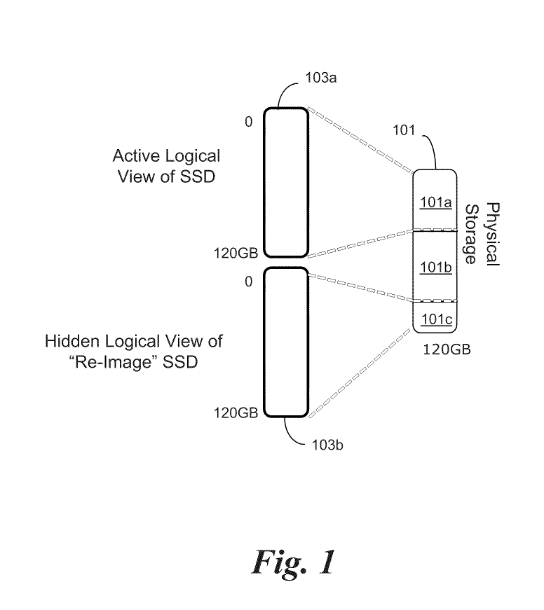

Referring to FIG. 1, there is shown an illustration of the logical views of physical storage, according to an embodiment of the invention. The SSD physical storage 101 is partitioned into two portions 101a and 101b. Partition 101a corresponds to the logical partition 103a and is the active used storage. Partition 101b is unused storage, or free space, that either personality may consume. Partition 101c corresponds to a hidden logical partition 103b. The hidden storage 101c may hold a re-image of the computing device.

When in an opportunistic mode, although data and storage is consumed by the re-image partition (101c), the storage device 101 will advertise the size of the device as a storage device that has all of the space available to the OS, when the device is queried for size. Thus, all of the storage can ultimately be used by the active personality, when needed.

In an embodiment, when an instant re-image is required, the hidden L2P table becomes the primary L2P table and (optionally) the physical storage associated with the previous active L2P table can be trimmed (de-allocated). The image in the hidden storage may be a clean copy of the environment written when the computing device was originally created, or an environment snapshot taken at a selected time. Copy on write implementations may be used to keep the environment up to date more dynamically.

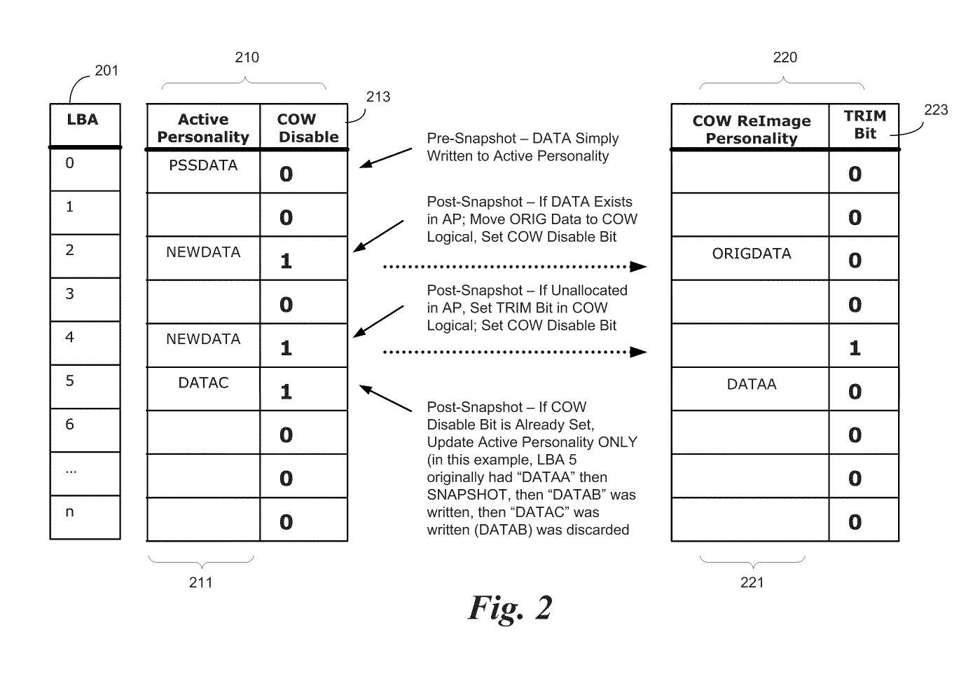

In an embodiment, a copy on write (COW) mechanism is used as illustrated in FIG. 2. This COW methodology avoids duplicating storage in the re-Image content, and thus, saves space. The logical block address (LBA) 201 for each storage location is indicated on the left. The active personality, or active image, 210 for each LBA includes data 211 and a COW disable indicator, or bit, 213 to indicate whether the data has been changed and needs to be copied into the secondary personality.

The secondary personality, or hidden logical partition 220 includes the original data 221, for rolling back, and a trim indicator, or bit, 223 to indicate that the data in that LBA was originally blank (zero) and the block should be trimmed upon reimaging, nor does the original data need to be saved in the secondary personality, as it was zero/blank. The trim bit allows the allocated block of changes data to be reallocated as a free block.

In an embodiment, when the data to be used for a re-image has not changed, the data need not be redundantly written to the secondary personality, and is merely maintained in the active personality. This is the baseline. Since data has not yet changed, no re-image is necessary. When data in LBA 2 is changed in the active personality, the COW engine writes the original data to LBA 2 of the secondary personality before the new data is written into the active personality. If the data in LBA 4 is changed (previously blank, or all zeroes=0x00 hex), then the trim bit in secondary personality is then set to a “1” to indicate that the data may be discarded, or trimmed, upon a re-image activation.

In most cases, only the first new data change will be copied into the secondary personality, because subsequent data changes are not the original (snapshot) data. For instance, if LBA 5 is changed from the original DATAA to DATAB, the COW disable bit of LBA 5 in the active personality is set to “1” and the original data, DATAA, is copied to LBA 5 of the secondary personality. Thus, if LBA 5 is changed again to DATAC, the COW disable bit prohibits the original data in the secondary personality from being overwritten. Therefore, a clean re-image of the original data is maintained in the secondary personality, without being corrupted by a series of new data changes. LBAs that have not changed do not need to be copied into the secondary personality, resulting in sparse storage rather than a full copy.

When the computer requires a re-image, the re-image personality 220 may be parsed. If the COW bit is a 1, in the active personality, then the saved data block should be written into the active personality, but when the COW bit is 0, then the original block has not changed, and need not be rewritten.

In an embodiment, when COW is initiated for a block, the logical block information for the changed block may be remapped so that the re-image personality is indexed into the original data block, and the new data is actually written into a new, free storage block. This saves the expense of actually having to copy the data to the re-image personality. This may also be referred to as redirect-on-write. In embodiments, the mapping may be for sets of blocks rather than individual blocks to minimize the size of the mapping tables.

The COW method takes a performance penalty the first time a new block is written, but takes no performance hit for reads. Thus, it is optimized for read operations. Other embodiments may use other methods of saving data in the re-image personality using logical block mapping, for instance, that have less of a write penalty.

In an embodiment, when a new snapshot command is received, the COW disable bits are cleared and any data in the re-image personality can be cleared and sent back to free unallocated storage space. This starts the COW process from scratch, where the image existing at the time of the snapshot is the image to be used for a re-image. Only when new block is written, or a block is changed, will data the snapshot date be written into the secondary personality and COW or trim bits be set. This simplifies the act of creating a snapshot to a bare minimum, with almost an imperceptible performance penalty.

Given that L2P tables set up an inherently “sparse” storage view of the logical namespace, along with no performance penalty for highly dispersed physical storage enables a novel capability referred to as “opportunistic cannibalization.” In an embodiment, the primary active view will use physical storage from the “free space” pool as long as it exists. If the free space pool is exhausted, and the device is operating in “opportunistic cannibalization” mode, the primary view/L2P table may cannibalize the storage from the re-image view. In a scenario where cannibalization has occurred, re-image operations are no longer available until re-image status is reset. In this case, existing methods may be used to re-image the device. Generally, the device will have a state indicating whether re-imaging is available and whether it is in “reserved mode” or “opportunistic cannibalization” mode.

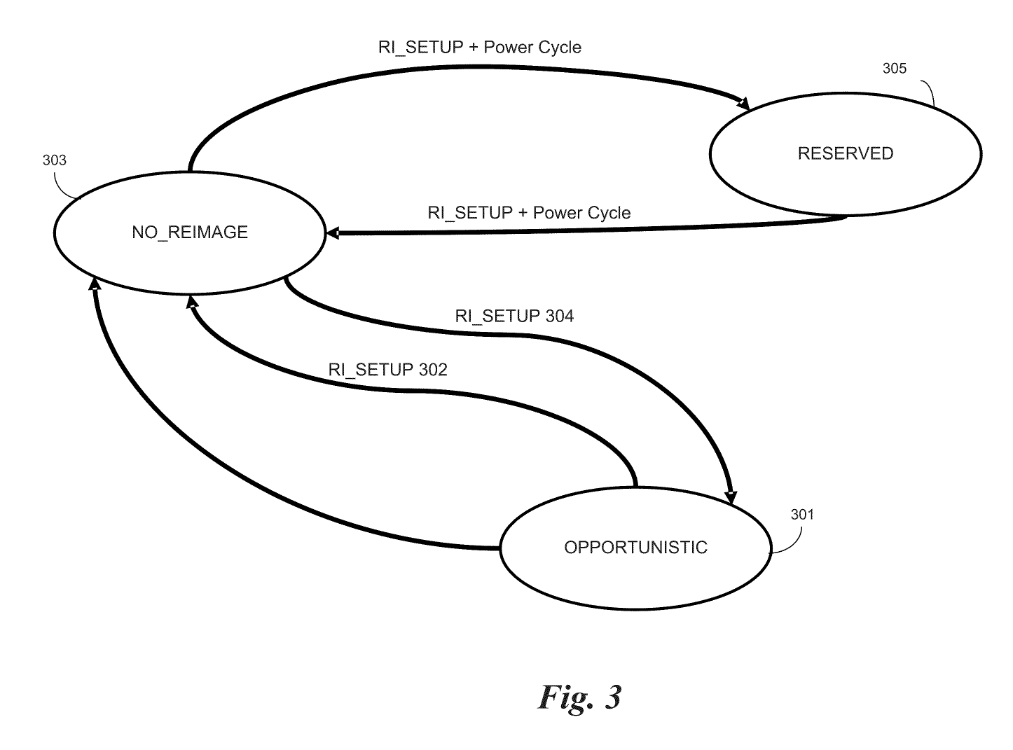

The general state transitions of the device are represented in FIG. 3. When the device is set to OPPORTUNISTIC mode 301, if all free physical storage is exhausted, the primary personality may consume storage that has been previously allocated to the Re-Image personality. In this case, the device will change its state to NO_REIMAGE 303 and trim, or deallocate, all storage that was allocated for the re-image personality. An re-image setup command 302, RI_SETUP, may be used to change the device state.

If the active personality releases enough storage for a Re-Image to be again maintained, then an RI_SETUP command 304 may change the device status back to OPPORTUNISTIC 301. A new snapshot of the storage (Re-Image data) may be effectively taken by ensuring that all trim bits in the secondary personality are reset to “0” and COW disable bits in the active personality are set to “1”. At this point, the secondary personality exists for a Re-Image, but takes up almost no physical storage, as there is no copied data.

In some embodiments, it may be important for the device to maintain the secondary personality Re-Image. In this case, the device may be set to RESERVED 305. The RESERVED state allows for COW to the secondary personality into a reserved portion of physical storage, but does not allow for cannibalization of the reserved storage if the active personality requires more physical storage space. Changing the state to/from RESERVED state may typically require a power cycle, as well as a state change, because the free space on the drive must be permanently changed, as far as the operating system (OS) is concerned. The storage in the reserved portion will not be available to the OS or applications until the state is changed and another power cycle is initiated. When queried, the storage device will return size information that excludes the reserved area, appearing to be smaller.

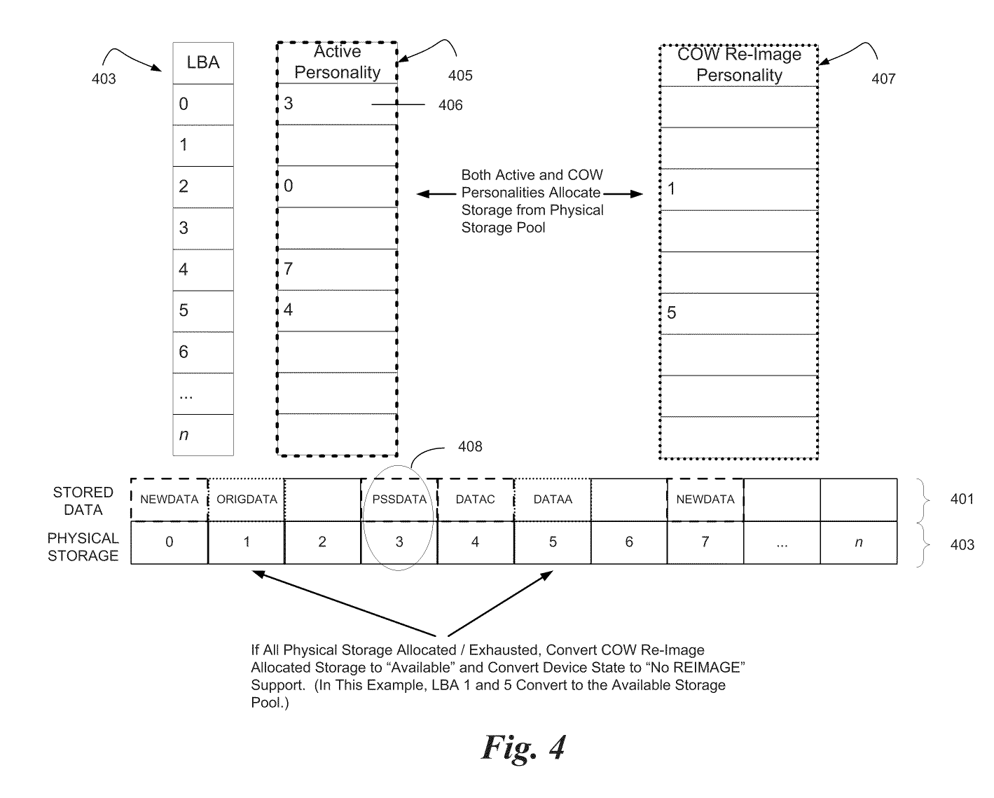

FIG. 4 illustrates how the data from both personalities is stored in physical storage, corresponding to the data in FIG. 2, and the logical pointers to the physical storage. In an OPPORTUNISTIC state, data from the active personality and the secondary personality (Re-Image) may be interspersed in the physical storage. Data may be stored in physical storage 401 in blocks corresponding to a LBA 403. The numbers shown in the active and secondary personality lists indicates the physical block in storage that holds the data. For instance, as shown in the active personality 405, LBA-0 shows a value of 3 (406). The data PSSDATA is thus stored in physical block 3 (408). As this data has not changed, there is no old data stored in the second personality for this LBA. LBA-2 for the active personality has changed data, as also shown in FIG. 2, which is stored in physical storage block 0. When COW is enabled, for instance, in the opportunistic state, the secondary personality maintains the old data from LBA-2 in physical block 1.

In an embodiment implementing cannibalistic behavior, when all physical storage has been allocated or exhausted, the COW Re-Image area in physical storage may be converted to available and allocated active personality storage space and a signal sent to convert the device state to “No Reimage” support. The device will also report a new state when queried by host based software. When this happens, LBA-1 and LBA 5 of the physical storage will be converted to the available storage pool.

Using cannibalistic techniques and sparse partitions along with reserving storage use for the active personality, and switching back and forth have little deleterious effects when solid state storage (SSD) is used because there is no issue with performance degradation due to accessing logical storage that is non-sequential.

If the full capacity of the device is required by the user, the technique will treat the reserved area as free space. As space is freed by the user, the state may be returned to an opportunistic state using a current snapshot or pulling a known good snapshot from remote storage. This allows an instant re-image procedure to be applied until the device is forced into another No Re-Image state.

Because the secondary personality already points to the original or snapshot data blocks in physical storage, a re-image may be effected merely by changing the LBA map in the active personality to match what is in the secondary personality. In other words, the Re-Image may be effected by activating a new logical to physical mapping of what the device exposes.

In an embodiment, an authorized host, or local entity, may issue a command to Re-Image the device or take a snapshot of the current environment. In another embodiment, a remote terminal may either force a snapshot to be taken, rewrite the snapshot/original data in the secondary personality to roll-back or update the environment, or force the secondary personality to Re-Image the device. When an update or new environment is to be used as the next re-image, the remote terminal may send a command indicating the new image blocks are to be written into the COW re-image personality and tell the storage device to set the COW disable bit to 1, which corresponds to the LBA in the active personality.

In some cases, this may be done when a user is having performance problems, but the system has not crashed. IT may write the new image to the user's device, give the user time to back up application data, and then initiate the re-image. Once the re-image is complete, the user may restore his/her application data and resume on a machine that no longer has the same performance issues.

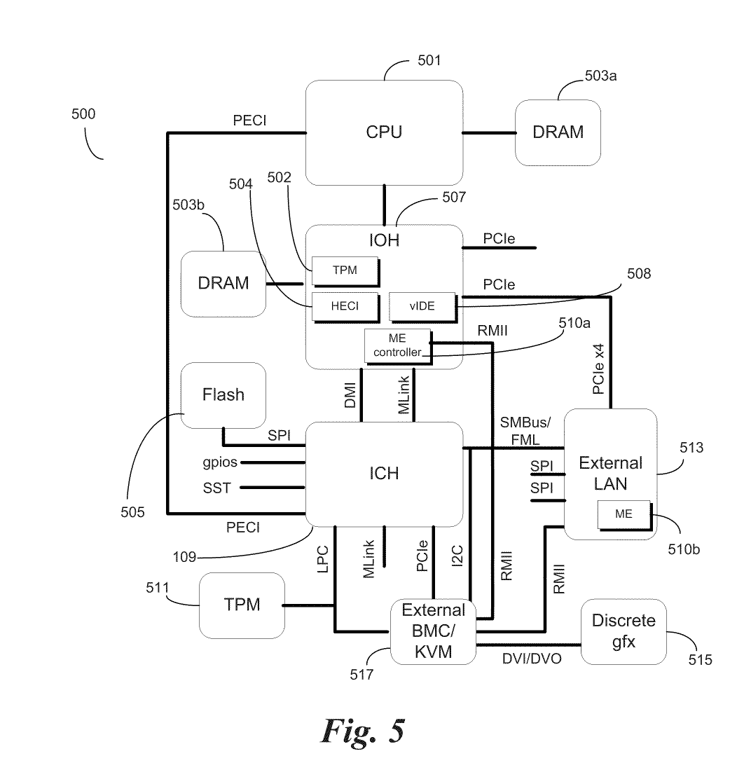

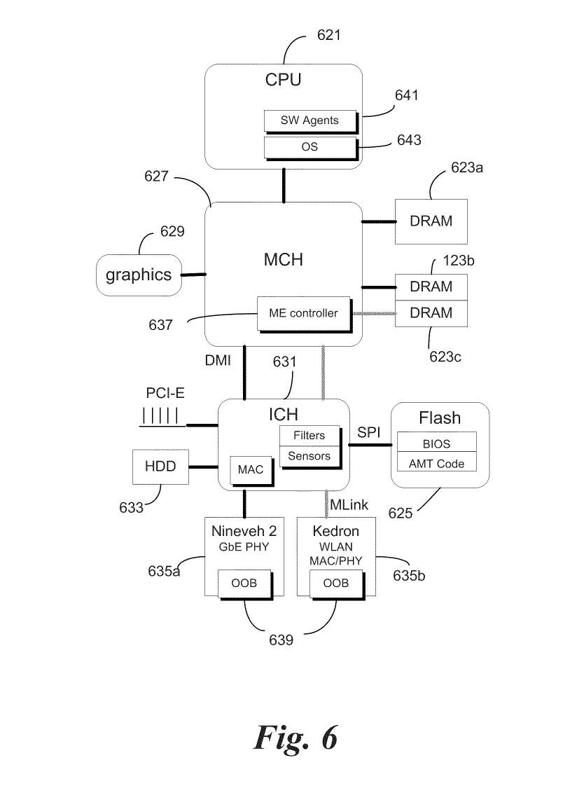

FIGS. 5 and 6 are block diagrams illustrating both exemplary server and client platforms which may be utilized in implementation of various embodiments of the invention and configured to allow out-of-band communication to control the re-imaging. It will be understood that these figures are used for illustration only, and embodiments of the invention may be implemented on a variety of platform architectures.

Referring now to FIG. 5, there is shown a block diagram illustrating an exemplary server platform, according to embodiments of the invention. In one server embodiment, a platform comprises processor 501 communicatively coupled to DRAM 503a-b, an input/output Hub (IOH) 507, flash memory 505, and an input/output controller hub (ICH) 509. In this server embodiment, the north bridge (memory controller not shown) resides in the processor 501.

Processor 501 may be any type of processor capable of executing software, such as a microprocessor, digital signal processor, microcontroller, or the like. Though FIG. 5 shows only one such processor 501, there may be one or more processors in platform hardware 500 and one or more of the processors may include multiple threads, multiple cores, or the like.

The platform may have a trusted platform module (TPM) 511 and may be connected to an external LAN 513. The platform may also be coupled with a discrete graphics controller 515 via an external baseboard management controller (BMC) or keyboard-video-mouse (KVM) interface 517. KVM is a chip that allows multiplexing many possible local/remote keyboards/mice/video sources. In this exemplary embodiment, the IOH 507 may have additional components for TPM 502, host embedded controller interface (HECI) 504, virtual IDE (vIDE) 508, and micro-controller engine (ME) controller 510a. The HECI 504 is similar to a PCI device and is the means by which the basic input output system (BIOS) and operating system (OS) may communicate with the ME 510a. The micro-controller engine may also be known as a manageability engine, Intel® AMT or VPro™ device, for instance, available from Intel Corporation, for use with remote management of the platform. The ME 510a may enable out-of-band communication with the host platform to initiate re-imaging, taking snapshots of the known good environment, updating the re-image data or changing the re-image state of the device. The vIDE 508 enables virtual indirection to a LAN 513. In an embodiment, the ME controller 510a may have a limited amount of ROM to store its code. In this case, the ME controller 510a may access a partitioned, or protected, portion of the flash 505, or other solid state memory, having ME or AMT code. Resources in the ICH 509 may be required for the ME controller 510a to perform other AMT functions. The external LAN 513 may also have a separate ME controller component 510b.

The ME controller 510a or 510b may program other chips on the platform via a number of buses and communication paths within the platform. The link between the processor 501 and the IOH 507 may comprise a point to point (pTp) interconnection link, quick path interconnect (QPI) or other communication interface. The memory controller hub (MCH), or north bridge, is typically built into the processor 501 for servers, and is not shown.

In an alternative embodiment, the external BMC 517 may be used to resume from sleep mode, S3, using a protected storage instead of using the embedded ME 510. In this case, the BMC 517 would require an appropriate bus to be able to communicate to the platform chips to ensure appropriate configuration when running the stored boot script. However, a preferred embodiment is to utilize the ME 510a to ensure that the boot script and other information are in a hardware protected area of the flash 505.

The AMT code may reside in a protected portion of flash memory 505. This portion is inaccessible to the OS and firmware (BIOS/EFI). In some embodiments, there may be a BAR register in the ICH 509. Upon boot, the BIOS sets the register in the ICH 509 to define which portions of the flash are accessible to the BIOS and which portion is accessible only to the ME 510. If the ICH BAR register indicates that a portion of the flash is inaccessible to the BIOS, the memory will be unmappable and completely invisible and inaccessible to the firmware and OS. Other methods of sequestering portions of the memory via a hardware protection scheme may be devised and used by those of skill in the art.

FIG. 6 illustrates an exemplary client platform, according to embodiments of the invention. In an exemplary client embodiment, the platform comprises a processor 621 having possible software agents 641 and an operating system 643. The processor 621 may be communicatively coupled to DRAM or solid state memory 623a-c via a memory controller hub (MCH), or north bridge 627. The MCH 627 may communicate to a graphics interface 629 and an ICH 631. The ICH 631 may communicate with a hard disk drive (HDD) 633, flash memory 625 and one or more network interface devices 635a-b, for instance the Ninevah 2 Ethernet controller or the Kedron wireless LAN adapter, both available from Intel Corp. The network devices 635a-b may have an out-of-band (OOB) communications component 639. In this embodiment, the ME subsystem 637 may be built into the MCH 627. The flash memory 625 comprises the firmware code (BIOS), protected AMT code and manufacturer settings. It will be apparent to one of skill in the art that processors 501 and 621 may comprise single or multi-processors and/or may have more than one core.

The embodiment shown in FIG. 6 may operate in a similar manner as that shown in FIG. 5. Both embodiments may utilize a manageability engine (ME) 510, 637 to store and retrieve boot scripts in a protected memory, for instance flash 505, 625. A resume from wake may process the boot script on the ME controller 510, 637, or send the appropriate commands and data to the processor 501, 621 for processing by system firmware. Other embodiments may utilize the host processor for controlling the re-image processes and be devoid of an ME.

It will be understood that the COW model, as described above may be more efficient for some Re-Image personalities. However, brute force logical to physical mapping may be more efficient for other Re-Image personalities. In some embodiments, multiple modes of Re-Imaging may be supported on the same platform.

The techniques described herein are not limited to any particular hardware or software configuration; they may find applicability in any computing, consumer electronics, or processing environment. The techniques may be implemented in hardware, software, or a combination of the two.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A computing platform comprising:
at least one processor coupled to a storage device,
the storage device comprising a first portion storing an active execution personality and a second portion to store a re-image personality comprising a logical snapshot for use in re-imaging the computing platform, wherein the second portion is variable in size based in part on a re-image machine state and a number of blocks of data in the active execution personality that have changed since the logical snapshot was saved to the second portion; and
a re-imaging agent executing on the at least one processor configured to initiate and/or maintain a logical snapshot in the re-imaging personality for re-imaging the computing platform, and also configured to respond to requests corresponding to maintaining and updating the logical snapshot.

2. The platform as recited in claim 1, wherein the storage device comprises solid state memory.

3. The platform as recited in claim 1, wherein the re-imaging agent is configured to recapture blocks used by the re-imaging portion when additional storage is needed, and wherein upon recapture, is also configured to update the re-image machine state of the platform to indicate that no re-image is possible.

4. The platform as recited in claim 3, wherein the re-imaging agent is configured to create a new logical snapshot and update the re-image machine state of the platform to indicate that re-image is possible, responsive to a request from one of a local or remote re-imaging control process.

5. The platform as recited in claim 1, wherein the re-imaging agent is configured to power cycle the platform and update the re-image machine state of the platform to indicate that blocks used by the re-image personality are not to be recaptured.

6. The platform as recited in claim 1, wherein the re-imaging agent is configured to initiate an instant re-imaging of the platform where the active execution personality is replaced by the re-imaging personality, responsive to a request from one of a local or remote re-imaging control process.

7. The platform as recited in claim 1, wherein the re-imaging agent is configured to use copy on write (COW) methodology in maintaining the re-imaging personality.

8. The platform as recited in claim 7, further comprising COW logic configured to, in response to a block of data corresponding to the active execution personality changing from a current data block to a new data block, remap a first logical block address table corresponding to the active execution personality to write the new data block into an available block of storage, and remap a second logical block address table corresponding to the re-imaging personality to utilize the current data block in storage.

9. The platform as recited in claim 7, further comprising:
a first logical block address (LBA) table corresponding to the active execution personality; and a
a second logical block address (LBA) table corresponding to the re-imaging personality; and
a disable flag corresponding to logical block addresses in the first LBA table to indicate whether a logical block is to be retrieved from the re-imaging personality responsive to a re-imaging request.

10. The platform as recited in claim 9, further comprising:
a trim bit corresponding to logical block addresses in the second LBA table to indicate whether the logical block is to be returned to available storage after performing a re-imaging operation.

11. The platform as recited in claim 1, wherein the re-imaging agent is configured to perform a logical to physical remapping of blocks to swap context of the active execution personality with the re-imaging personality, responsive to a request from one of a local or remote re-imaging control process to re-image the platform.

12. The platform as recited in claim 1, wherein the storage device is configured to return size information when queried, and the size information returned varies based on the re-image machine state and logical snapshot size.

13. The platform as recited in claim 12, wherein when the re-image machine state is either Opportunistic or No-Reimage then the size returned is a full physical size of the storage device, and when the re-image machine state is Reserved then the size returned is reduced at least by the logical snapshot size.

14. A machine implemented method, comprising:
setting a re-imaging machine state on a platform coupled to a storage device;
when the re-imaging machine state is set to No-Reimage, enabling the use of all storage on the storage device by an active personality on the platform;
when the re-imaging machine state is set to Opportunistic, storing and maintaining a secondary personality on the storage device in a hidden partition and also allowing the active personality to utilize all storage on the storage device including the hidden partition, when needed; and
when the re-imaging machine state is set to Reserved, storing and maintaining the secondary personality on the storage device in a hidden partition and disallowing the active personality to utilize any storage in the hidden partition.

15. The method as recited in claim 14, further comprising:
changing the re-image machine state responsive to a request for a new state by one of a local or a remote re-imaging process.

16. The method as recited in claim 14, further comprising:
responsive to a query of storage device size, returning a variable size by the storage device, the variable size based in part on the re-image machine state and a size allotted for the secondary personality.

17. The method as recited in claim 14, wherein the storage device comprises a solid state storage device.

18. The method as recited in claim 14, further comprising:
recapturing blocks used by the secondary personality when additional storage is needed by the active personality; and
updating the re-image machine state of the platform to indicate that no re-image is possible as a No-Reimage state.

19. The method as recited in claim 18, further comprising:
creating a new logical snapshot of the active personality as the second personality; and
updating the re-image machine state of the platform to indicate that re-image is possible, as one of an Opportunistic or Reserved state, responsive to a request from one of a local or remote re-imaging control process.

20. The method as recited in claim 14, further comprising:
performing a power cycle of the platform; and
and updating the re-image machine state of the platform as Reserved, to indicate that blocks used by the secondary personality are not to be recaptured.

21. The method as recited in claim 14, further comprising:
initiating an instant re-imaging of the platform where the active personality is replaced by the secondary personality, responsive to a request from one of a local or remote re-imaging control process.

22. The method as recited in claim 14, wherein the storing and maintaining the secondary personality further comprises copy on write (COW) methodology.

23. The method as recited in claim 22, further comprising:
responsive to a block of data corresponding to the active personality changing from a current data block to a new data block, remapping a first logical block address table corresponding to the active personality to write the new data block into an available block of storage, and remapping a second logical block address table corresponding to the secondary personality to utilize the current data block in storage.

24. The method as recited in claim 22, wherein the active personality corresponds to a first logical block address (LBA) table, wherein the secondary personality corresponds to a second logical block address (LBA) table, and wherein a disable flag corresponds to logical block addresses in the first LBA table to indicate whether a logical block is to be retrieved from the re-imaging personality responsive to a re-imaging request.

25. The method as recited in claim 24, wherein a trim bit corresponds to logical block addresses in the second LBA table to indicate whether the logical block is to be returned to available storage after performing a re-imaging operation.

26. The method as recited in claim 14, further comprising:
performing a logical to physical remapping of blocks to swap context of the active personality with the secondary personality, responsive to a request from one of a local or remote re-imaging control process to re-image the platform.

27. A machine readable storage medium, having instructions stored thereon, the instructions when executed on a machine cause the machine to:
set a re-imaging machine state on a platform coupled to a storage device;
when the re-imaging machine state is set to No-Reimage, enable the use of all storage on the storage device by an active personality on the platform;
when the re-imaging machine state is set to Opportunistic, store and maintain a secondary personality on the storage device in a hidden partition and also allow the active personality to utilize all storage on the storage device including the hidden partition, when needed; and
when the re-imaging machine state is set to Reserved, store and maintain the secondary personality on the storage device in a hidden partition and disallow the active personality to utilize any storage in the hidden partition.

28. The medium as recited in claim 27, further comprising instructions to:
change the re-image machine state responsive to a request for a new state by one of a local or a remote re-imaging process.

29. The medium as recited in claim 27, further comprising instructions to:
responsive to a query of storage device size, return a variable size by the storage device, the variable size based in part on the re-image machine state and a size allotted for the secondary personality.

30. The medium as recited in claim 27, wherein the storage device comprises a solid state storage device.

31. The medium as recited in claim 27, further comprising instructions to:
recapture blocks used by the secondary personality when additional storage is needed by the active personality; and
update the re-image machine state of the platform to indicate that no re-image is possible as a No-Reimage state.

32. The medium as recited in claim 31, further comprising instructions to:
create a new logical snapshot of the active personality as the second personality; and
update the re-image machine state of the platform to indicate that re-image is possible, as one of an Opportunistic or Reserved state, responsive to a request from one of a local or remote re-imaging control process.

33. The medium as recited in claim 27, further comprising instructions to:
perform a power cycle of the platform; and
and update the re-image machine state of the platform as Reserved, to indicate that blocks used by the secondary personality are not to be recaptured.

34. The medium as recited in claim 27, further comprising instructions to:
initiate an instant re-imaging of the platform where the active personality is replaced by the secondary personality, responsive to a request from one of a local or remote re-imaging control process.

35. The medium as recited in claim 27, wherein the storing and maintaining the secondary personality further comprises copy on write (COW) methodology.

36. The medium as recited in claim 35, further comprising instructions to:
responsive to a block of data corresponding to the active personality changing from a current data block to a new data block, remap a first logical block address table corresponding to the active personality to write the new data block into an available block of storage, and remap a second logical block address table corresponding to the secondary personality to utilize the current data block in storage.

37. The medium as recited in claim 35, wherein the active personality corresponds to a first logical block address (LBA) table, wherein the secondary personality corresponds to a second logical block address (LBA) table, and wherein a disable flag corresponds to logical block addresses in the first LBA table to indicate whether a logical block is to be retrieved from the re-imaging personality responsive to a re-imaging request, and wherein a trim bit corresponds to logical block addresses in the second LBA table to indicate whether the logical block is to be returned to available storage after performing a re-imaging operation.

38. The medium as recited in claim 27, further comprising instructions to:
perform a logical to physical remapping of blocks to swap context of the active personality with the secondary personality, responsive to a request from one of a local or remote re-imaging control process to re-image the platform.
